(19) United States
(12) Patent Application Publication
(10) Pub. No.: US 2008/0111705 A1
(43) Pub. Date: May 15, 2008

(54) EARTHQUAKE ALERT METHOD AND SYSTEM USING WIRELESS TERMINALS

(75) Inventor: Byung-Su LEE, Gumi-si (KR)

Correspondence Address: Jefferson IP Law, LLP, 1730 M Street, NW, Suite 807, Washington, DC, 20036, US

(73) Assignee: Samsung Electronics Co., LTD., Suwon-city (KR)

(21) Appl. No.: 11/770,119

(22) Filed: Jun. 28, 2007

(30) Foreign Application Priority Data
Nov. 10, 2006 (KR) 111080/2006

(51) Int. Cl. G08B 21/00

(52) U.S. Cl. 340/690

(57) ABSTRACT

An earthquake alert system using wireless terminals and a method for providing an earthquake alert are provided. The system includes at least one wireless terminal for detecting vibration greater than a predetermined amount and transmitting vibration information generated based on the vibration, and a mobile communication network for transmitting the vibration information to an emergency management agency, and if it is notified by the emergency management agency that the vibration information is caused by an earthquake, determining a propagation direction of the earthquake and transmitting an earthquake alert message to wireless terminals located in the earthquake propagation direction.

### PRIORITY

This application claims the benefit under 35 U.S.C. § 119 (a) of a Korean patent application filed in the Korean Intellectual Property Office on Nov. 10, 2006 and assigned Serial No. 2006-111080, the entire disclosure of which is hereby incorporated by reference.

### BACKGROUND OF THE INVENTION

1. Field of the Invention

The present invention relates generally to an earthquake alert system. More particularly, the present invention relates to an earthquake alert system and method using wireless terminals.

2. Description of the Related Art

A succession of vibrations that shake the Earth's surface is the definition of ‘earthquake’. The occurrence of an earthquake causes a great cost of life and heavy damage to property. A scale of seismic intensity is a measure used to indicate the strength of vibrations of an earthquake at a site, i.e. a compilation of human perception and a shaking pattern of surrounding things or a structure. The seismic intensity scale is represented using acceleration (cm/sec²) or acceleration of gravity (1 g=980 cm/sec²), wherein cm/sec² is represented by gal, and 1 g corresponds to 980 gal. A conventional earthquake alert system predicts the occurrence of an earthquake by detecting a seismic intensity scale and minimizes damage caused by the earthquake by controlling operations of dangerous devices or allowing the emergency management agency to notify people of the occurrence of the earthquake by various means. However, due to the very fast propagation speed of earthquakes, it is very difficult to quickly cope with the earthquakes, resulting in severe accidents, and in the case of a slight (minor) shock of an earthquake, a user cannot easily perceive the earthquake in an initial stage. Thus, a method of notifying of the occurrence of an earthquake as soon as possible is still insufficient. Accordingly, a method of detecting the occurrence of an earthquake using wireless terminals has become popular to people and quickly notifying users of the occurrence of the earthquake is suggested in order to minimize damage caused by the earthquake.

### SUMMARY OF THE INVENTION

An aspect of the present invention is to substantially address at least the above problems and/or disadvantages and to provide at least the advantages below. Accordingly, an aspect of the present invention is to provide a method of detecting the occurrence of an earthquake, predicting an earthquake direction, and quickly providing an earthquake alert message to wireless terminals located in the earthquake direction, by means of cooperation between wireless terminals, a mobile communication network, and an emergency management agency.

According to one aspect of the present invention, an earthquake alert system using wireless terminals is provided. The system comprises at least one wireless terminal for detecting vibration greater than a predetermined amount and transmitting vibration information generated based on the vibration to a mobile communication network, the mobile communication network for, if the vibration information is received from a predetermined area more than a predetermined number of times for a predetermined time, transmitting the vibration information to an emergency management agency, and if it is notified by the emergency management agency that the vibration information is caused by an earthquake, determining a propagation direction of the earthquake and transmitting an earthquake alert message to wireless terminals located in the earthquake propagation direction, and the emergency management agency for determining whether the vibration information of each wireless terminal, which has been received from the mobile communication network, is caused by an earthquake, and if it is determined that the vibration information is caused by an earthquake, notifying the mobile communication network of the determination result.

According to another aspect of the present invention, an earthquake alert method using wireless terminals is provided. The method comprises detecting vibration greater than a predetermined amount and transmitting vibration information generated based on the vibration to a mobile communication network, if the mobile communication network receives the vibration information from wireless terminals located in a predetermined area more than a predetermined number of times for a predetermined time, transmitting the vibration information to an emergency management agency, determining whether the vibration information of each wireless terminal is caused by an earthquake, and if it is determined that the vibration information is caused by an earthquake, notifying the mobile communication network of the determination result, and receiving the determination result, determining a propagation direction of the earthquake, and transmitting an earthquake alert message to wireless terminals located in the earthquake propagation direction.

### BRIEF DESCRIPTION OF THE DRAWINGS

The above and other aspects, features and advantages of the present invention will become more apparent from the following detailed description of certain exemplary embodiments taken in conjunction with the accompanying drawing in which:

FIG. 1 is a block diagram illustrating a wireless terminal according to an exemplary embodiment of the present invention;

FIG. 2 is a diagram illustrating a configuration of an earthquake alert system according to an exemplary embodiment of the present invention; and

FIG. 3 is a flowchart illustrating an earthquake alert method according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of the exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

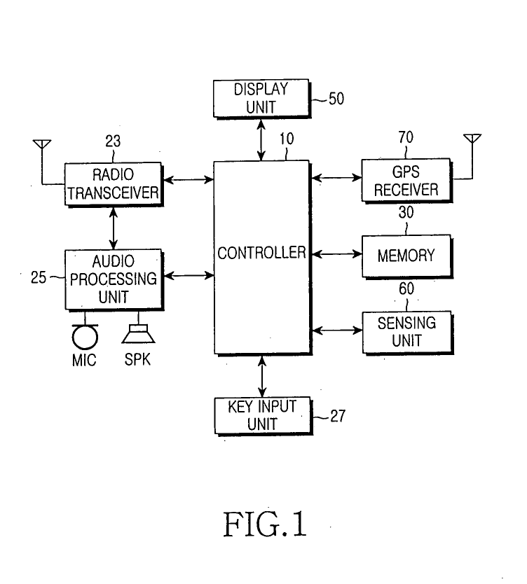

FIG. 1 is a block diagram illustrating a wireless terminal according to an exemplary embodiment of the present invention.

Referring to FIG. 1, a radio transceiver 23 includes a Radio Frequency (RF) module (not shown) and a modem (not shown). The RF module includes an RF transmitter (not shown) for up-converting a frequency of a signal to be transmitted and amplifying the frequency up-converted signal and an RF receiver (not shown) for low noise amplifying a received signal and down-converting a frequency of the low noise amplified signal. The modem includes a transmitter (not shown) for encoding and modulating a signal to be transmitted and a receiver (not shown) for decoding and demodulating a received signal.

An audio processing unit 25 can include a codec including a data codec and an audio codec. The data codec processes packet data, and the audio codec processes an audio signal such as voice and a multimedia file. The audio processing unit 25 converts a digital audio signal received from the modem to an analog audio signal using the audio codec and reproduces the analog audio signal, or converts an analog audio signal generated by a microphone (MIC) to a digital audio signal and transmits the digital audio signal to the modem. The codec may exist separately or be included in a controller 10.

A key-input unit 27 includes keys for inputting number and character information and function keys for setting various functions.

A memory 30 may include a program memory and a data memory. The program memory can store programs for controlling a general operation of the wireless terminal. The memory 30 according to an exemplary embodiment of the present invention may store a seismic intensity table used to compare a level of vibration (vibration amount) of the wireless terminal, which is detected by a sensing unit 60, and a relevant seismic intensity scale.

A display unit 50 may include a Liquid Crystal Display (LCD) or Organic Light Emitting Diodes (OLED) and outputs various types of display information created by the wireless terminal. If the LCD or OLED is implemented in a touch screen method, the display unit 50 may operate as an input unit for controlling the wireless terminal together with the key-input unit 27.

The sensing unit 60 includes at least one sensor for detecting a motion of the wireless terminal. It is assumed that the sensing unit 60 according to an exemplary embodiment of the present invention includes at least one of a terrestrial magnetism sensor or an acceleration sensor. Thus, the sensing unit 60 according to an exemplary embodiment of the present invention detects vibration of the wireless terminal due to an earthquake (e.g., change of acceleration).

A Global Positioning System (GPS) receiver 70 is a device for performing a GPS function, which is a position recognition system using satellites. The GPS receiver 70 according to an exemplary embodiment of the present invention may provide a position of the wireless terminal when vibration corresponding to an earthquake is detected.

A controller 10 controls the entire operation of the wireless terminal and changes or controls an operation mode. If vibration of the wireless terminal, which is greater than a predetermined amount, is detected by the sensing unit 60, the controller 10 according to an exemplary embodiment of the present invention transmits the detected vibration amount to a mobile communication network as vibration information. In this case, the vibration information contains the vibration amount, the time when the vibration occurred, and a position where the vibration occurred. The controller 10 may output an earthquake alert message to a user according to a notification result received from the mobile communication network on whether the vibration is caused by an earthquake.

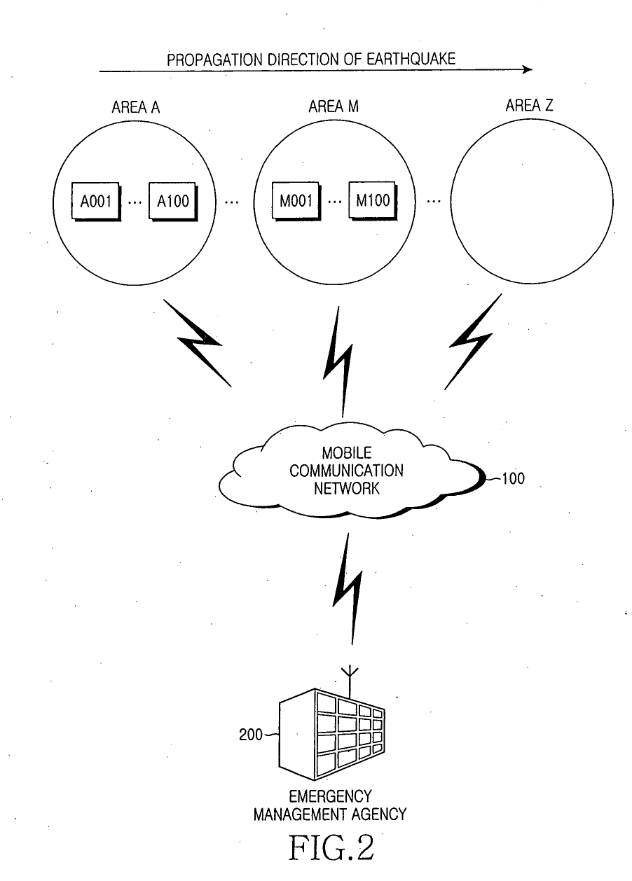

FIG. 2 is a diagram illustrating a configuration of an earthquake alert system according to an exemplary embodiment of the present invention.

Referring to FIG. 2, a mobile communication network 100 is a network for performing voice and data communications by providing a mobile communication environment to wireless terminals using base stations, a base station controller, a mobile communication switch, a server, a database, and the like. It is assumed that the mobile communication network 100 provides a mobile communication environment desired by a user using various communication standards, such as Code Division Multiple Access (CDMA), Global System for Mobile Communications (GSM), Wireless Broadband (Wibro), and High Speed Downlink Packet Access (HSDPA). According to an exemplary embodiment of the present invention, the mobile communication network 100 receives vibration information containing a vibration amount greater than a predetermined value from a wireless terminal. If such vibration information is continuously received from a plurality of wireless terminals in a predetermined area at a similar time slot, the mobile communication network 100 transmits the vibration information to an emergency management agency 200 and waits to receive notification on whether the vibration information corresponds to an earthquake, from the emergency management agency 200. If the mobile communication network 100 is notified by the emergency management agency 200 that vibration of each wireless terminal, which is contained in the vibration information, is caused by an earthquake, the mobile communication network 100 determines a propagation direction of the earthquake and transmits an earthquake alert message to wireless terminals located in the earthquake propagation direction (the earthquake propagation direction is determined by tracking each occurrence time of the vibration contained in the notification of the emergency management agency 200).

The emergency management agency 200 copes with natural calamities, such as earthquakes, floods, and tidal waves, and other states of emergency. The emergency management agency 200 provides a determination result in response to an earthquake occurrence determination request according to an exemplary embodiment of the present invention, which is received from the mobile communication network 100.

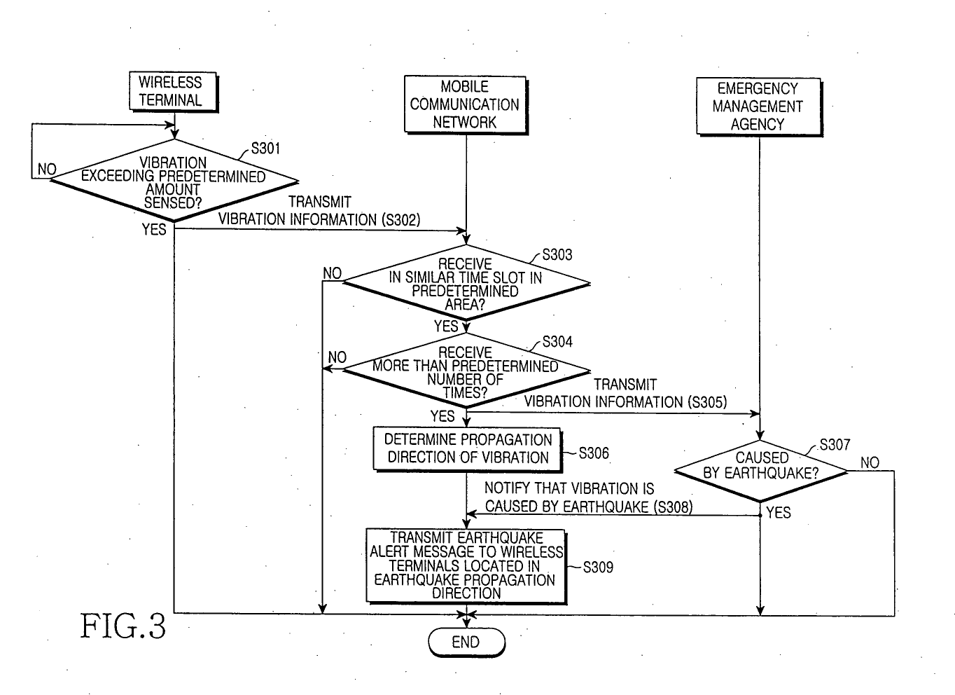

FIG. 3 is a flowchart illustrating an earthquake alert method according to an exemplary embodiment of the present invention. The earthquake alert method will be described with reference to FIG. 2.

If a wireless terminal detects vibration greater than a predetermined amount in step S301, the wireless terminal transmits vibration information to the mobile communication network 100 in step S302.

The controller 10 of the wireless terminal continuously measures vibration of the wireless terminal, which is detected by the sensing unit 60, and determines whether the vibration of the wireless terminal exceeds a predetermined value (vibration amount). The vibration amount corresponding to the predetermined value is based on a seismic intensity table using acceleration (cm/sec², gal) detected by the sensing unit 60.

[Seismic intensity table]

| | | Acceleration | | |
|---|---|---|---|---|
| Scale | Name | (gal) | Description | Reference |
| 0 | Unfelt | Less than | Vibrations are recorded | Hanging objects swing a |
| | | 0.8 | by instruments. People | little, or people can hear |
| | | | do not feel any Earth | a sound but cannot feel |
| | | | movement. | shaking. |
| I | Slight | 0.8~2.5 | People at rest upstairs | People can notice |
| | earthquake | | notice shaking. In | shaking in a calm |
| | | | particular, only people | environment but not |
| | | | sensitive to an | long. People standing |
| | | | earthquake can notice | indoors might not realize |
| | | | shaking. | that an earthquake is |
| | | | | occurring. |
| II | Weak | 2.5~8 | All people can notice | Hanging objects swing |
| | earthquake | | shaking. Windows | back and forth. People |
| | | | shake a little bit. | standing might feel |
| | | | | shaking but do not feel |
| | | | | any movement while |
| | | | | moving. Many sleeping |
| | | | | people are awakened. |
| III | Minor | 8~25 | Houses shake; | People are frightened a |
| | earthquake | | windows rattle; | little. Sleeping people |
| | | | hanging objects swing. | are awakened but not |
| | | | People can notice that | rushed out or scared. |
| | | | water in a dish is | Many people outdoors |
| | | | slopping. | feel shaking. People |
| | | | | might not realize an |
| | | | | earthquake while |
| | | | | moving. |
| IV | Intermediate | 25~80 | Doors swing; Small | Sleeping people are |
| | earthquake | | objects move or are | frightened and |
| | | | turned over; liquid | awakened. People are |
| | | | spills from glasses. | scared. Trees and poles |
| | | | Pedestrians feel | shake. Damage is slight |
| | | | movement. Many | in poorly built buildings. |
| | | | people are rushed | No structural damage. |
| | | | outward. | |
| V | Strong | 80~250 | Walls might crack; | People have difficulty |
| | earthquake | | tombstones fall down; | standing; considerable in |
| | | | chimneys, stonewalls, | poorly built buildings; |
| | | | and embankments | weak ground (surface) |
| | | | might be damaged. | cracks; some furniture |
| | | | | falls down. |
| VI | Violent | 250~400 | Houses suffer damage | People cannot walk |
| | earthquake | | of less than 30%; | without help |
| | | | landslides occur; the | |
| | | | ground cracks. People | |
| | | | cannot stand. | |
| VII | Destructive | More than | Houses suffer damage | Nothing |
| | earthquake | 400 | of more than 30%; | |
| | | | landslides occur; large | |
| | | | cracks appear in the | |
| | | | ground, or the ground | |
| | | | moves in waves or | |
| | | | ripples. | |

For example, if the vibration amount detected by the sensing unit 60 is 2.3 gal (corresponding to a slight earthquake), the controller 10 ignores the vibration (Null), and if the vibration amount is 2.6 gal (corresponding to a weak earthquake), the controller 10 determines that the vibration amount exceeds the predetermined value (2.5 gal). Thus, the controller 10 determines a position and time at which 2.6 gal is detected, stores vibration information containing the vibration amount (2.6 gal), the position, and the time, and transmits the vibration information to the mobile communication network 100. The controller 10 acquires information on the position where the vibration is detected from the GPS receiver 70 or the mobile communication network 100. In this case, the controller 10 may display that vibration corresponding to an earthquake has been detected, whereby a user can take shelter in a safe area.

The mobile communication network 100, which has received the vibration information, determines in step S303 whether the vibration information is received in a similar time slot in a predetermined area and in step S304 whether the vibration information is received more than a predetermined number of times.

In order to prevent that vibration of a wireless terminal due to a happening occurring in daily life of a user is misunderstood as an earthquake, the current embodiment is based on an area, time, and a number of occurring times. That is, in the current embodiment, it is assumed that when the vibration information is transmitted from a plurality of wireless terminals to the mobile communication network 100 in a similar time slot in a specific area, the vibration of the wireless terminals is caused by an earthquake. For example, when the mobile communication network 100 receives vibration information from 100 wireless terminals A001 through A100 (based on number of occurring times) in an area A (based on an area) illustrated in FIG. 2 in a similar time slot or with a some time difference (based on time), the mobile communication network 100 determines that an earthquake has occurred in the area A. Similarly, if the mobile communication network 100 receives vibration information from 100 wireless terminals M001 through M100 in an area M illustrated in FIG. 2, the mobile communication network 100 determines that an earthquake has also occurred in the area M. The mobile communication network 100 applies the same criteria to vibration information received from wireless terminals located in a Z area and other areas, which are not shown in FIG. 2.

The mobile communication network 100 transmits the vibration information to the emergency management agency 200 in step S305 and determines a propagation direction of the earthquake in step S306.

The mobile communication network 100 transmits the vibration information received from wireless terminals in each area to the emergency management agency 200 and waits to receive a determination result of the emergency management agency 200 on whether the vibration information corresponds to an earthquake. The mobile communication network 100 determines a propagation direction of the earthquake. For example, by confirming an occurrence time and position contained in vibration information received from each of wireless terminals in the area A, areas (an area B through an area L) between the area A and the area M, and the area M, the mobile communication network 100 determines that vibration of the wireless terminals has occurred in a time sequence from the area A to the area M. By performing the operation of steps S303 through S306, the mobile communication network 100 can determine that the earthquake propagation direction leave toward the area Z.

The emergency management agency 200 determines based on the vibration information in step S307 whether the vibration of each wireless terminal is caused by an earthquake, and if it is determined that the vibration of each wireless terminal is caused by an earthquake, the emergency management agency 200 notifies the mobile communication network 100 in step S308 that the vibration of each wireless terminal is caused by an earthquake.

The emergency management agency 200, which has received the vibration information of each wireless terminal from the mobile communication network 100, can determine based on information obtained through various methods, such as a measurement result of a seismometer, whether the vibration (vibration information) of each wireless terminal is caused by an earthquake. If it is determined that the vibration of each wireless terminal is caused by an earthquake, the emergency management agency 200 notifies the mobile communication network 100 of the determination result (or transmits the determination result to the mobile communication network 100).

The mobile communication network 100, which has received the notification that the vibration of each wireless terminal is caused by an earthquake from the emergency management agency 200, transmits an earthquake alert message to wireless terminals located in the earthquake propagation direction in step S309.

The mobile communication network 100 transmits the earthquake alert message to the wireless terminals located in the earthquake propagation direction (e.g., the Z area) determined in step S306. The wireless terminals located in the earthquake propagation direction, which have received the earthquake alert message, display the earthquake alert message to users, whereby the users can quickly take shelter in safe areas. Furthermore, the mobile communication network 100 can receive information on whether another earthquake occurs, the earthquake propagation direction, or a seismic intensity scale from the emergency management agency 200. In this case, the mobile communication network 100 can transmit the earthquake alert message to wireless terminals located in the areas (e.g., the area A) where the earthquake has occurred.

As described above, according to exemplary embodiments of the present invention, by detecting the occurrence of an earthquake using wireless terminals and predicting a propagation direction of the earthquake, damage due to the earthquake can be minimized.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An earthquake alert system using wireless terminals, the system comprising:
at least one wireless terminal for detecting vibration greater than a predetermined amount and transmitting vibration information; and
a mobile communication network for receiving the transmitted vibration information and, if the vibration information is received from a predetermined area more than a predetermined number of times for a predetermined time, transmitting the vibration information to an emergency management agency, and if it is notified by the emergency management agency that the vibration information is caused by an earthquake, determining a propagation direction of the earthquake and transmitting an earthquake alert message to wireless terminals located in the earthquake propagation direction.

2. The system of claim 1, wherein the emergency management agency determines whether the vibration information of each wireless terminal, which has been received from the mobile communication network, is caused by an earthquake, and if it is determined that the vibration information is caused by an earthquake, notifies the mobile communication network of the determination result.

3. The system of claim 1, wherein the wireless terminal comprises:
a sensing unit for detecting vibration of the wireless terminal;
a Global Positioning System (GPS) receiver for providing a position of the wireless terminal; and
a controller for, if an amount of the vibration is greater than a predetermined value, confirming the time when the vibration occurred, generating vibration information and transmitting the vibration information to the mobile communication network.

4. The system of claim 3, wherein the vibration information comprises at least one of the vibration amount, the time when the vibration occurred, and the position where the vibration occurred.

5. The system of claim 3, wherein the sensing unit comprises an acceleration sensor.

6. The system of claim 1, wherein the mobile communication network determines the earthquake propagation direction using a time when the vibration occurred and a position of the wireless terminal where the vibration occurred, which are contained in the vibration information.

7. The system of claim 1, wherein the wireless terminals receive the earthquake alert message and display the earthquake alert message to users.

8. An earthquake alert method using wireless terminals, the method comprising:
detecting vibration greater than a predetermined amount and transmitting vibration information to a mobile communication network by a wireless terminal;
receiving the transmitted vibration information, and if the mobile communication network receives the vibration information from wireless terminals located in a predetermined area more than a predetermined number of times for a predetermined time, transmitting the vibration information to an emergency management agency by the mobile communication network;
determining whether the vibration information of each wireless terminal is caused by an earthquake, and if it is determined that the vibration information is caused by an earthquake, notifying the mobile communication network of the determination result; and
receiving the determination result, determining a propagation direction of the earthquake, and transmitting an earthquake alert message to wireless terminals located in the earthquake propagation direction.

9. The method of claim 8, wherein the determining of the propagation direction comprises tracking of each occurrence time and position contained in vibration information received from each of the wireless terminals.

10. The method of claim 8, wherein the vibration information comprises at least one of a vibration amount, a time when the vibration occurred, and a position where the vibration occurred.

11. The method of claim 8, further comprising receiving the earthquake alert message and displaying the earthquake alert message to users.

12. The method of claim 8, wherein the transmitting of the vibration information to the mobile communication network comprises:
determining whether the vibration detected by a sensing unit of the wireless terminal is greater than a predetermined amount;
if it is determined that the vibration is greater than the predetermined amount, confirming a position of the wireless terminal where the vibration occurred using a Global Positioning System (GPS) receiver of the wireless terminal; and
generating vibration information containing the vibration amount, the time when the vibration occurred, and the position of the wireless terminal where the vibration occurred, and transmitting the vibration information to the mobile communication network.

13. The method of claim 12, wherein the sensing unit of the wireless terminal comprises an acceleration sensor.

14. The method of claim 8, wherein the transmitting of the earthquake alert message comprises:
receiving by the mobile communication network the determination result and determining a propagation direction of the earthquake based on the time when the vibration occurred, and the position of the wireless terminal where the vibration occurred, which are contained in the vibration information; and
transmitting the earthquake alert message to wireless terminals located in the earthquake propagation direction.

15. A mobile communication network, comprising:
a receiver for receiving vibration information transmitted by wireless terminals;
a transmitter for transmitting the vibration information if the vibration information is received from a specified area more than a specified number of times within a specified timeframe.

16. The mobile communication network of claim 15, further comprising means for receiving a notification that the transmitted vibration information is caused by an earthquake.

17. The mobile communication network of claim 16, further comprising means for determining a propagation direction of the earthquake and transmitting an alert message to wireless terminals located in the earthquake propagation direction.

18. An earthquake alert method, comprising:
receiving vibration information transmitted by wireless terminals;
transmitting the vibration information if the vibration information is received from a specific area more than a specified number of times within a specified timeframe.

19. The earthquake alert method of claim 18, further comprising receiving a notification that the transmitted vibration information is caused by an earthquake.

20. The earthquake alert method of claim 19, further comprising determining a propagation direction of the earthquake and transmitting an alert message to wireless terminals located in the earthquake propagation direction.
